(19) United States
(12) Patent Application Publication
(10) Pub. No.: US 2022/0125240 A1
(43) Pub. Date: Apr. 28, 2022

(54) Air-Based Fryer Lids for Slow Cooker

(71) Applicant: Hamilton Beach Brands, Inc., Glen Allen, VA (US)

(72) Inventors: Derek A. McCullough, Richmond, VA (US); George W. Stamper, III, Quinton, VA (US); Paula L. Pennington, Mechanicsville, VA (US)

(21) Appl. No.: 17/076,961

(22) Filed: Oct. 22, 2020

(51) Int. Cl. A47J 37/06; A47J 36/06; A47J 36/32; A47J 36/20; A47J 47/16

(52) U.S. Cl. CPC A47J 37/0641; A47J 37/0664; A47J 47/16; A47J 36/32; A47J 36/20; A47J 36/06

(57) ABSTRACT

The present disclosure describes air-based fryer lids. The air-based fryer lid may include a main housing having one or more side walls, wherein within the main housing resides: a heating element, one or more fan members, a drive member, and a controller; and an oval-shaped base coupled to the main housing and comprising an air discharge opening, the base being sized and configured to cover and form a seal with a container of a slow cooker when placed on the container, wherein the heating element is configured to heat air of an air flow provided by the fan member, and wherein the fan member is configured to guide the heated air through the air discharge opening of the base and into the container of the slow cooker.

### FIELD OF THE INVENTION

The present invention relates generally to a kitchen appliance, and more particularly to air-based fryer lids configured for a slow cooker for cooking foodstuff.

### BACKGROUND

Kitchen appliances, and particularly air-based fryers and slow cookers, are well-known. However, as additional types of kitchen appliances are becoming available in the marketplace, consumers are running out of cabinet space within their homes to store all of these appliances. Thus, appliances that are adaptable for use with pre-existing appliances may be desired.

### SUMMARY

An embodiment of the present invention is directed to an air-based fryer lid. The air-based fryer lid includes a main housing and an oval-shaped base. The main housing has one or more side walls, wherein within the main housing resides: a heating element, one or more fan members, a drive member, and a controller. The oval-shaped base is coupled to the main housing and includes an air discharge opening, the base being sized and configured to cover and form a seal with a container of a slow cooker when placed on the container. The heating element is configured to heat air of an air flow provided by the fan member, and the fan member is configured to guide the heated air through the air discharge opening of the base and into the container of the slow cooker.

Another embodiment of the present invention is directed to an air-based fryer lid. The air-based fryer lid includes a base and a main housing. The main housing having one or more side walls extending upwardly from the base, wherein within the main housing resides: a heating element; one or more fan members; a drive member; a tilt sensor; and a controller in communication with the heating element, one or more fan members, drive member, and position sensor, wherein the tilt sensor is configured to communicate to the controller to shut off power to the heating element and the one or more fan members when the main housing is tilted at a predetermined angle relative to horizontal.

A further embodiment of the present invention is directed to a rest stand for an air-based fryer lid. The rest stand including a first arm and a second arm pivotably coupled with the first pair of arms, wherein, when in an open position, the second arm extends outwardly and perpendicularly from the first arm in opposing direction, and when in a closed position, the second arm extends outwardly and axially from the first arm.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1A is a top perspective view of an air-based fryer lid according to embodiments of the present invention.

FIG. 1B is a rear view of the air-based fryer lid of FIG. 1A.

FIG. 1C is a side view of the air-based fryer lid of FIG. 1A.

FIG. 1D is a bottom view of the air-based fryer lid of FIG. 1A.

FIG. 1E is a bottom perspective view of the air-based fryer lid of FIG. 1A.

FIG. 2 is a perspective view of an air-based fryer lid and slow cooker assembly according to embodiments of the present invention.

FIG. 3A is a side view of the air-based fryer lid of FIG. 1A with the main housing removed showing the internal components of the fryer lid.

FIG. 3B is a cross-sectional view of internal components of the air-based fryer of FIG. 3A.

FIG. 4 is an enlarged view of the air-based fryer lid of FIG. 1A showing the handle and safety cut off micro-switch.

FIG. 5A is a perspective view of a cooking basket according to embodiments of the present invention.

FIG. 5B is a top view of the cooking basket of FIG. 5A.

FIG. 5C is a partial cross-sectional view of the air-based fryer lid and slow cooker assembly of FIG. 2 showing the cooking basket placed within the container of the slow cooker.

FIG. 6A is a perspective view of an air-based fryer lid stand according to embodiments of the present invention (in an open position).

FIG. 6B is the air-based fryer lid stand of FIG. 6A in a closed position.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

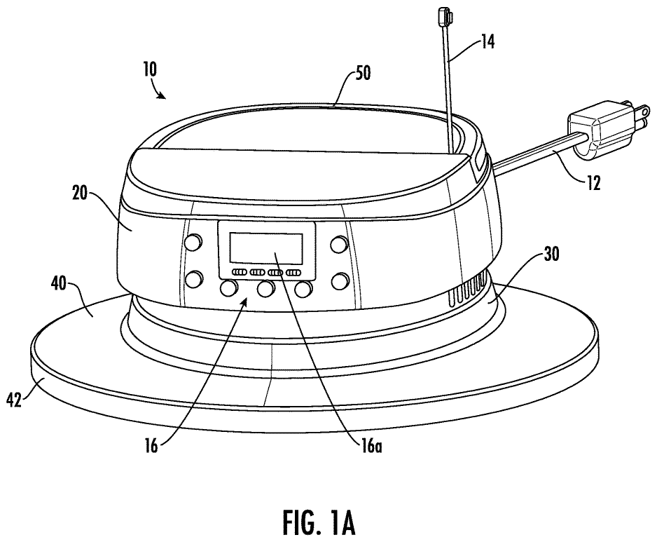

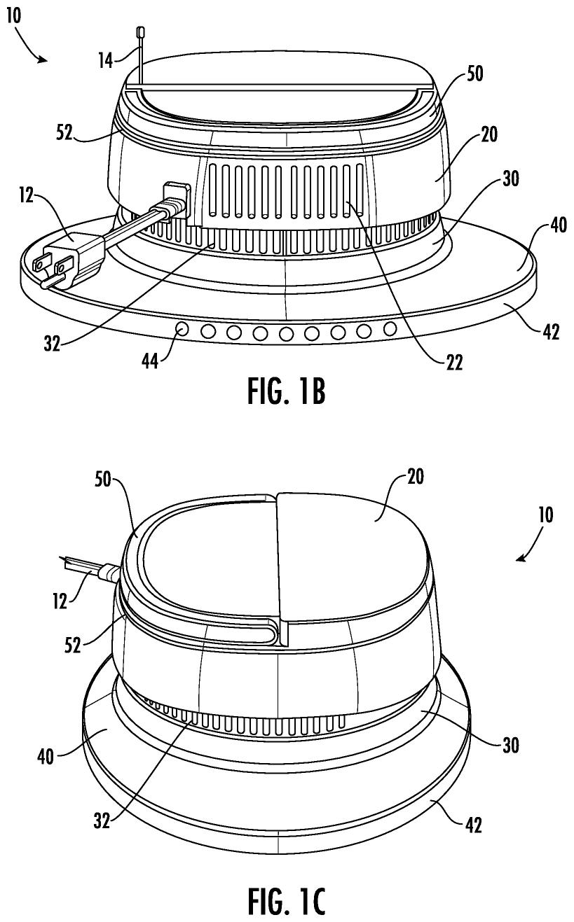

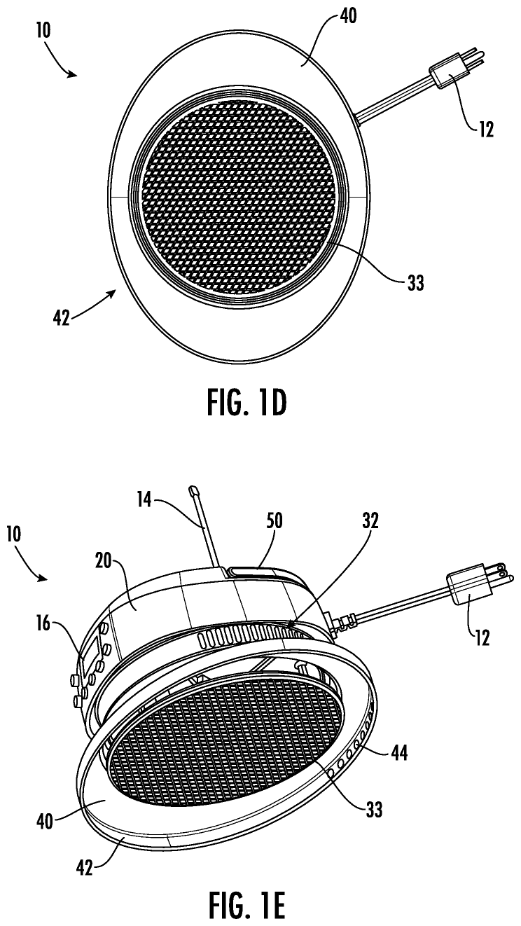

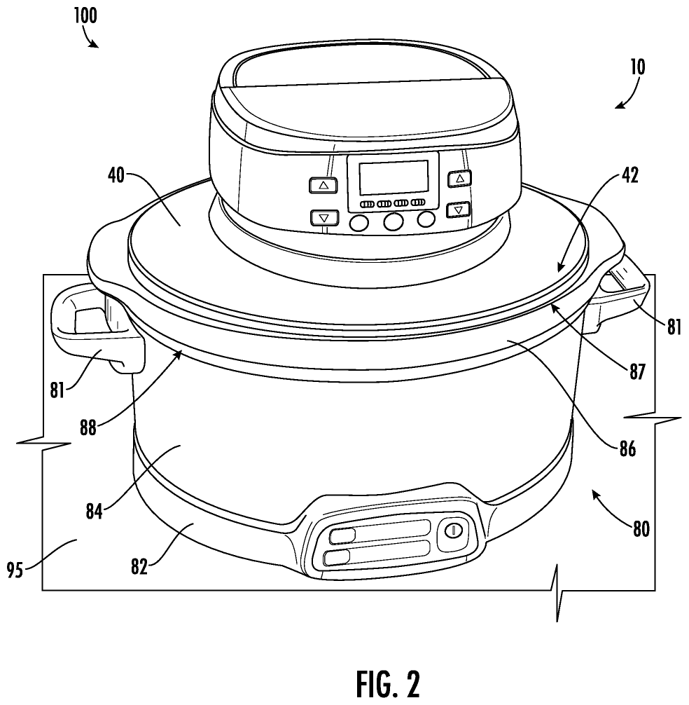

Referring now to the figures, an air-based fryer lid, designated broadly at 10, is illustrated in FIGS. 1A-1E. As described in further detail below, in some embodiments, the air-based fryer lid 10 of the present invention is configured to be used in combination with a slow cooker 80 (see, e.g., FIG. 2).

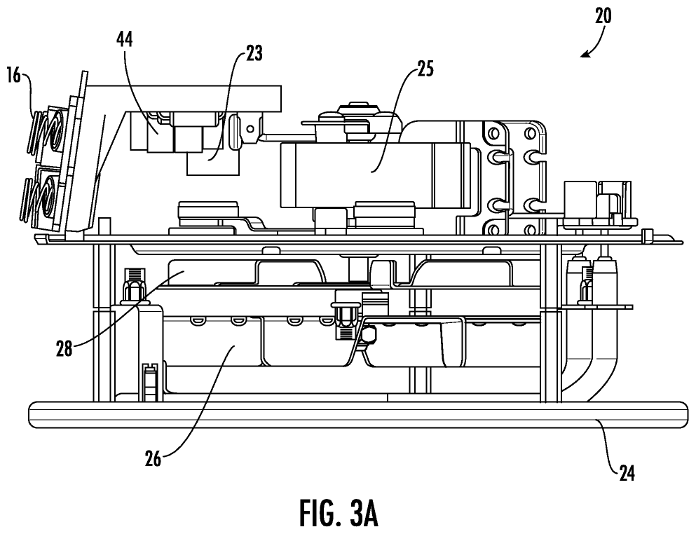

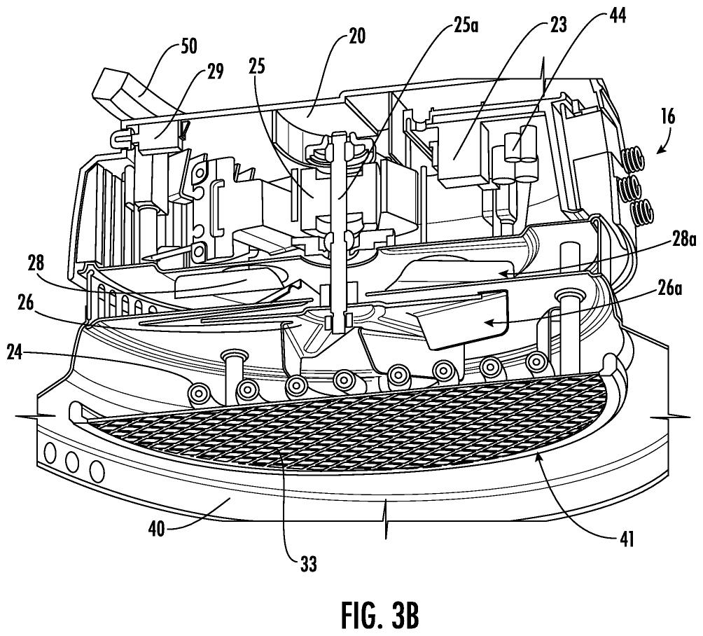

As shown in FIGS. 1A-1E, the air-based fryer lid 10 of the present invention includes a main housing 20, a base 40. In some embodiments, the air-based fryer lid 10 further includes a handle 50. The main housing 20 protects the internal components of the fryer lid 10, which will be discussed in further detail below with reference to FIGS. 3A-3B. As shown in FIG. 1B, the main housing 20 may comprise a plurality of perforations or slots 22. The internal components of the fryer lid 10 may generate heat during operation. The slots 22 in the main housing 20 may allow some of the heat generated by the internal components, and in particular, residual heat generated from the heating element 24, to escape and also allow air to circulate through the main housing 20, thereby helping to prevent the fryer lid 10 from overheating.

As shown in FIGS. 1A and 1E, the fryer lid 10 further includes a control panel 16 with an LED display 16a mounted to the main housing 20. The control panel 16 is in communication with a controller 23 (e.g., a printed circuit board or microprocessor) within the main housing 20, and is configured to be manually controlled by a user, for example, to control cooking time, cooking temperature, etc. In some embodiments, the control panel 16 may be a capacitive touch control panel. The LED display 16a is configured to visually display information about the fryer lid 10 to the user, such as time, temperature, preset cooking modes, and cook settings. The fryer lid 10 may further include an audible indicator, such as a buzzer, to signal to the user when cooking is complete. In some embodiments, the fryer lid 10 includes a power cord 12 extending outwardly from the main housing 20.

In some embodiments, the base 40 of the fryer lid 10 is coupled to the main housing 20 via a transition section 30. Similar to the main housing 20, and shown in FIGS. 1B, 1C, and 1E, the transition section 30 may also comprise a plurality of perforations or slots 32. The slots 32 in the transition section 30 allow for excess heat to exit the fryer lid before reaching the main housing 20 (i.e., allows air to be blown out of the fryer lid 10 by a cooling fan member 28).

As can be seen in FIGS. 1A, 1B, and 1D, the base 40 of the fryer lid 10 may be oval or elliptical in shape (when viewed from above or below). The oval or elliptical shape of the base 40 of the fryer lid 10 is sized and configured such that the fryer lid 10 may cover and form a seal with the container 86 of a slow cooker 80 having a corresponding oval or elliptical shape (see, e.g., FIG. 2). In some embodiments, the base 40 of the fryer lid 10 is sized to fit a 6-quart slow cooker 80. In some embodiments, the base 40 of the fryer lid 50 has at least a slightly arcuate cross-sectional profile, such that the exterior surface is generally convex and the interior surface of the base 40 is generally concave. In some embodiments, the base 40 is predominantly made of stainless steel. However, the base 40 may be made of a different material, such as a glass with a stainless steel rim.

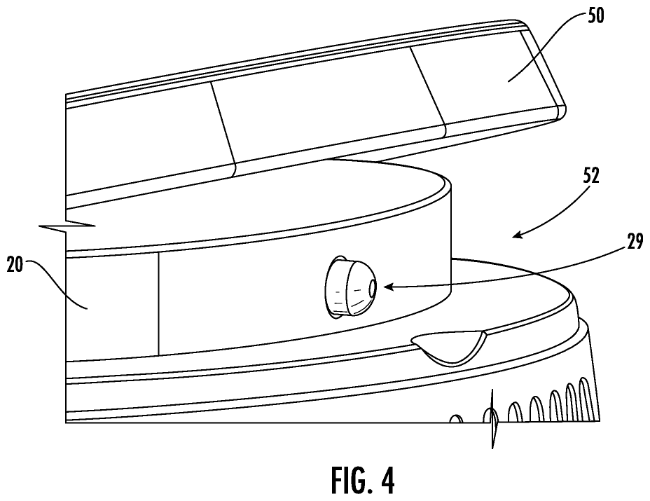

In some embodiments, the fryer lid 10 further includes a handle 50 that is pivotably coupled to a top portion of the main housing 20. The handle 50 may be configured to pivot up to an angle of about 90 degrees relative to the top of the main housing 20 (i.e., such that the handle 50 is generally perpendicular to the main housing 20 in an “open” position), thereby allowing a user to lift the fryer lid 10 away from a slow cooker 80. As shown in FIG. 1B, FIG. 1C, and FIG. 4, in some embodiments, the main housing 20 may comprise a recess 52 configured to receive the handle 50 when the fryer lid 10 is in use. The handle 50 is configured to fit within the recess 52 when pivoted to a “closed” position.

FIG. 2 illustrates an air-based fryer lid and slow cooker assembly 100 according to embodiments of the present invention in which the fryer lid 10 described herein is used in combination with a slow cooker 80. In some embodiments, as shown in FIG. 2, the slow cooker 80 may include an outer housing 84 and a container 86. The outer housing 84 may have a base 82 and a side wall 84s extending therefrom. At least portions of the side wall 84s and the base 82 define a cavity within the outer housing 84. The outer housing 84 may further have a housing rim 88 that defines an opening to the cavity. In some embodiments, the base 82, the side wall 84, and the housing rim 88 are generally oval or elliptical in shape when viewed from above or below. The outer housing 84 may be formed of a metallic material.

In some embodiments, the base 82 of the slow cooker 80 may include several generally spaced apart protrusions or feet (not shown) extending downwardly from a bottom surface thereof for supporting the slow cooker 80 on a support surface 95, such as a countertop, and spacing the bottom surface of the base 82 at least slightly above the support surface 95.

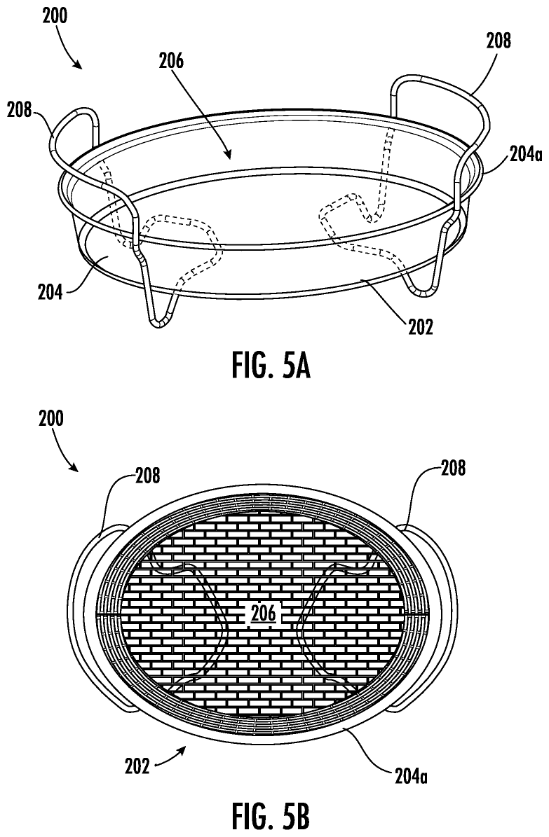

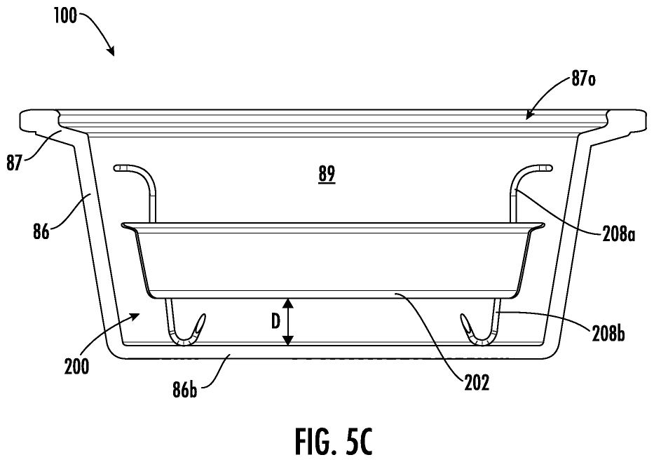

The container 86 of the slow cooker 80 has a generally hollow interior 89 (see, e.g., FIG. 5C). In some embodiments, the container 86 may comprise a container rim 87 that defines an opening 87o for accessing the interior 89 of the container 86. The interior 89 of the container 86 is capable of retaining contents (e.g., foodstuff) therein. In some embodiments, the container rim 87 may be a top or upper-most horizontal edge of a side wall of the container 86. Alternatively, the container rim 87 may be at least a portion of a ledge spaced inwardly and at least slightly downwardly from the upper-most horizontal edge of the side wall of the container 86.

The container 86 is sized and shaped to removably fit within the cavity of the outer housing 84. In some embodiments, the container 86 is oval or elliptical in shape. More specifically, an exterior of the container 86 is at least slightly smaller than the cavity of the outer housing 84 such that at least a majority of the container 84 fits within the cavity of the outer housing 84. This allows the container 86 to be easily removed from the outer housing 84 to facilitate cleaning of the container 86 without exposing the outer housing 84, and specifically the electrical components of the slow cooker 80, to water and/or cleaning detergents or solvents. In some embodiments, the container 86 may be formed of a ceramic material. However, the container 86 may be made of a different material that is capable of functioning as described herein.

It is noted that within or on the outer housing 84, the slow cooker 80 may include additional components for the power and operation thereof, such as, electronics to control operation, sensors, and the like. These components may be of conventional construction and need not be described in detail herein.

As discussed above, and shown in FIG. 2, the base 40 of the fryer lid 10 is sized and configured such that the fryer lid 10 may cover and form a seal with the container 86 of a slow cooker 80 having a corresponding oval or elliptical shape. As shown in FIGS. 1A-1C and FIG. 1E, in some embodiments, the base 40 of the fryer lid 10 may have an annular flange or lip 42. In some embodiments, when placed on the slow cooker 80, the base 40 of the fryer lid 10 covers the entire opening 87o of the container 86 such that the entire outer periphery of the base 40 of the fryer lid 10 engages and/or is placed adjacent to the container rim 87 of the slow cooker 80. For example, as shown in FIG. 2, the base 40 of the fryer lid 10 may have an outer periphery that is at least slightly smaller than an outer periphery of the container rim 87. This allows at least a portion of the outer periphery of the base 40 of the fryer lid 10 (or lip 42) to rest on a ledge (or container rim 87) that is at least slightly inwardly from the outer periphery of the container 86 of the slow cooker 80 (see, e.g., FIG. 5C), thereby creating a seal between the fryer lid 10 and the slow cooker 80. In some embodiments, the outer periphery of the base 40 of the fryer lid 10 may match or be about the same size as the outer periphery of the container 86 of the slow cooker 80.

Referring now to FIGS. 3A-3B, the primary internal components of the air-based fryer lid 10 of the present invention are illustrated. These components reside within the main housing 20 of the fryer lid 10. As shown in FIGS. 3A-3B, the fryer lid 10 may include a heating element 24, a cooking fan member 26, a cooling fan member 28, a drive member 25, and a safety cut off micro-switch 29. Each of these components is in communication with the controller 23 (e.g., a printed circuit board or microprocessor) and may be controlled through the control panel 16 mounted to the main housing 20.

The drive member 25 (e.g., a pole motor) is coupled to the cooking fan member 26 and the cooling fan member 28 via a drive shaft 25a. The drive member 25 is configured to rotate the drive shaft 25a which rotates the fan members 26, 28. In some embodiments, the cooking fan member 26 and the cooling fan member 28 are configured to direct airflow in different directions. For example, in some embodiments, the cooking fan member 26 is configured to guide air downward toward the heating element 24 and the cooling fan member 28 is configured to guide air outward to keep heat away from internal components within the main housing 20 (e.g., to help prevent the fryer lid 10 from overheating). In some embodiments, the cooking fan member 26 and/or the cooling fan member 28 may comprise one or more flanges 26a, 28a that extend downwardly or upwardly, respectively, that help guide the air in the desired direction.

The heating element 24 is configured to heat the air within the transition area 30 of the fryer lid 10. For example, as the cooking fan member 26 rotates (i.e., by drive shaft 25a), air is blown from the transition area 30 and the flanges 26a of the cooking fan member 26 guide the air heated by the heating element 24 downward through an air discharge opening 41 in the base 40 of the fryer lid 10. When the fryer lid 10 is used in combination with a slow cooker 80, the heated air is guided into the container 86 of the slow cooker 80, thereby cooking foodstuff contained therein. In some embodiments, the fryer lid 40 may comprise a heating element guard 33. The guard 33 extends across the air discharge opening 41 in the base 40. In some embodiments, the guard 33 is a wire mesh.

As shown in FIG. 3B and FIG. 4, in some embodiments, the air-based fryer lid 10 may further include a safety cut off micro-switch 29. The micro-switch 29 may be located within the recess 52 of the main housing 20. The micro-switch 29 provides a safety feature to the fryer lid 10. In some embodiments, the micro-switch 29 may be configured to cut off power to the fryer lid 10, for example, when a user tries to lift the fryer lid 10 during operation. When the handle 50 is in the closed position (i.e., residing within the recess 52 of the main housing 20), the handle 50 contacts or pushes radially inward the micro-switch 29 which sends a signal to the controller 23 that power may continue to be supplied to the fryer lid 10. When the handle 50 is raised away from within the recess 52 (i.e., lifted from a closed position to an opened position), contact (or the radial force) between the handle 50 and the micro-switch 29 is removed which sends a signal to the controller 23 to power off the fryer lid 10. Other known methods for determining the position of the handle 50 may be used for the micro-switch 29, for example, an infrared sensor.

In some embodiments, the fryer lid 10 may include one or more tilt sensors 44 which provide another safety feature. As shown in FIGS. 3A-3B, in some embodiments the tilt sensor 44 may be located as part of or adjacent to the controller 23. The tilt sensor 44 is in communication with the controller 23 and is configured to send a signal to the controller 23 to power off the fryer lid 10 (e.g., shut off the heating element 24 and cooking fan member 26), if the fryer lid 10 is tilted at a predetermined angle (e.g., greater than 20 degrees) relative to horizontal. Exemplary types of tilt sensors that may be used include, but are not limited to, a ball type sensors and accelerometers.

Referring now to FIGS. 5A-5C, a cooking basket 200 according to embodiments of the present invention is illustrated. The cooking basket 200 has a bottom 202 and one or more side walls 204 extending upwardly therefrom. Together the bottom 202 and side walls 204 form a cavity 206 capable of retaining contents (e.g., foodstuff) therein. In some embodiments, the cooking basket 200 is sized and configured to fit within the interior 89 of the container 86 of the slow cooker 80 (see, e.g., FIG. 5C). For example, in some embodiments, the cooking basket 200 may be oval or elliptical in shape (when viewed from above or below) corresponding to the container 86 of the slow cooker 80 having a similar oval or elliptical shape.

The cavity 206 of the cooking basket 200 is configured to hold foodstuffs, for example, when the cooking basket 200 is placed within the container 86 of the slow cooker 80. In some embodiments, the cooking basket 200 may include one or more wireform members 208 coupled to the side wall 204. In some embodiments, the wireform members 208 may be configured to serve as both a handle and stand for the cooking basket 200. For example, as shown in FIGS. 5A-5C, in some embodiments, one end of each of the wireform members 208 may extend above the side wall 204 (i.e., the handle portion 208a) and the opposing end may extend underneath the bottom 202 of the basket 200 (i.e., the stand portion 208b).

As shown in FIG. 5C, in some embodiments, the stand portion 208b of the wireform members 208 is configured such that the bottom 202 of the cooking basket 200 is held a distance (D) above the bottom 86b of the container 86 of the slow cooker 80. Holding the bottom 202 of the cooking basket 200 above (and away) from the bottom 86b of the container 86 (via wireform members 208) allows the heated air generated from the fryer lid 10 to flow around the foodstuffs contained within the cavity 206 of the cooking basket 200. In some embodiments, the bottom 202 and sides wall(s) 204 of the cooking basket 200 are formed from wire mesh. The wire mesh allows the heated air from the fryer lid 10 to easily flow around the foodstuff placed in the cavity 206 of the cooking basket 200.

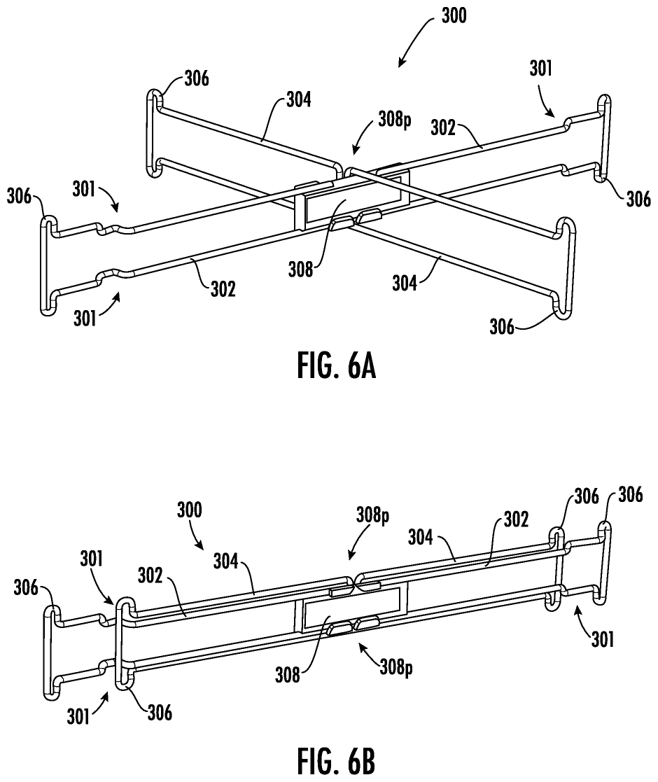

Referring now to FIGS. 6A-6B, a rest stand 300 according to embodiments of the present invention is illustrated. The rest stand 300 may be used with an air-based fryer lid 10 as described herein. As shown in FIGS. 6A-6B, the rest stand 300 includes a base 308 and a pair of arms 302, 304 coupled to the base 308. The first arm 302 is fixed to the base 308. The second arm is pivotally coupled to the base 308 and held in place at its pivot axis by the fixed arm 302.

As shown in FIG. 6A, when the rest stand 300 is in an “open” position, the second arm 304 pivots about a pivot point 308p in the base 308 to extend outwardly and perpendicularly from the base 308 (and first arm 302) in opposing direction. When placed in the open position, the arms 302, 304 form an “X” and together provide a surface to hold or “rest” the fryer lid 10, for example, when the fryer lid 10 is removed from the slow cooker 80. As shown in FIG. 6B, when the rest stand 300 is in a “closed” position, the second arm 304 pivots about the pivot point 308p to extend outwardly and axially from the base 308 (i.e., in the same direction as the first arm 302). When placed in the closed position, the rest stand 300 has a generally “flat” profile, thereby allowing the stand 300 to be easily stored until further use.

In some embodiments, the first arm 302 comprises at least one recess 301. The recess 301 is configured to receive and hold an end portion 306 of arm 304. For example, as shown in FIG. 6B, when the rest stand 300 is placed in the closed position, the second arm 304 pivots until the respective end 306 of the arm 304 is received by the recess 301. The recess 301 is configured to help hold the rest stand 300 in a closed position during storage. In another embodiment there are clips integral to base 308 to hold the pivoting arm 304 when in the closed position, in which the recess 301 is removed. In some embodiments, the upwardly bent end portions 306 of each arm 302, 304 may be configured such that the fryer lid 10 is held stably and not allowed to fall off of the rest stand 300. The rest stand 300 is designed symmetrically along its length-wise axis such that there is no defined upward orientation when in the open position.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An air-based fryer lid, comprising:
a main housing having one or more side walls, wherein within the main housing resides:
a heating element;
one or more fan members;
a drive member; and
a controller in communication with the heating element and drive member; and
an oval-shaped base coupled to the main housing and comprising an air discharge opening, the base being sized and configured to cover and form a seal with a container of a slow cooker when placed on the container;
wherein the heating element is configured to heat air of an air flow provided by at least one of the fan members, and wherein the fan member is configured to guide the heated air through the air discharge opening of the base and into the container of the slow cooker.

2. The air-based fryer lid defined in claim 1, in combination with the slow cooker, the slow cooker comprising:
an outer housing having a base and a side wall extending therefrom, the side wall having an exterior surface and an opposing interior surface, at least portions of the interior surface of the side wall and base defining a cavity within the outer housing, the outer housing having a housing rim defining an opening to the cavity; and
a container having a generally hollow interior and a container rim defining an opening for accessing the interior thereof, the interior being capable of retaining contents therein, the container being sized and shaped to removably fit within the cavity of the outer housing,
wherein the oval-shaped base of the fryer lid fits within an upper edge of the container of the slow cooker and forms a seal therewith.

3. The air-based fryer lid defined in claim 1, further comprising a handle pivotably coupled to the main housing.

4. The air-based fryer lid defined in claim 3, further comprising a safety switch configured to disable power to the fryer lid when the handle is pivoted from a closed position to an opened position.

5. The air-based fryer lid defined in claim 1, further comprising a heating element guard extending across the air discharge opening of the oval-shaped base.

6. The air-based fryer lid defined in claim 1, wherein the one or more fan members include a cooking fan member configured to guide air downwardly toward the slow cooker and a cooling fan member configured to guide air outwardly away from the main housing.

7. The air-based fryer lid defined in claim 1, further comprising a tilt sensor residing within the main housing, the tilt sensor being configured to disable power to the fryer lid when the main housing is tilted at an angle of about 20 degrees or greater relative to horizontal.

8. The air-based fryer lid defined in claim 2, wherein the heated air cooks foodstuff placed within the container of the slow cooker.

9. The air-based fryer lid defined in claim 2, further comprising a cooking basket sized to fit within the hollow interior of the container of the slow cooker.

10. The air-based fryer lid defined in claim 9, wherein the cooking basket comprises at least two supports that hold the cooking basket a distance above a bottom surface of the container of the slow cooker.

11. The air-based fryer lid defined in claim 2, further comprising a rest stand configured to hold the base when the fryer lid is removed from the slow cooker.

12. An air-based fryer lid, comprising:
a base; and
a main housing having one or more side walls extending upwardly from the base, wherein within the main housing resides:
a heating element;
one or more fan members;
a drive member;
a tilt sensor; and
a controller in communication with the heating element, drive member, and position sensor,
wherein the tilt sensor is configured to communicate to the controller to shut off power to the heating element and the one or more fan members when the main housing is tilted at a predetermined angle relative to horizontal.

13. The air-based fryer lid defined in claim 12, wherein the predetermined angle is about 20 degrees or greater relative to horizontal.

14. The air-based fryer lid defined in claim 12, in combination with a slow cooker, the slow cooker comprising:
an outer housing having a base and a side wall extending therefrom, the side wall having an exterior surface and an opposing interior surface, at least portions of the interior surface of the side wall and base defining a cavity within the outer housing, the outer housing having a housing rim defining an opening to the cavity; and
a container having a generally hollow interior and a container rim defining an opening for accessing the interior thereof, the interior being capable of retaining contents therein, the container being sized and shaped to removably fit within the cavity of the outer housing,
wherein the base of the fryer lid fits within an upper edge of the container of the slow cooker and forms a seal therewith.

15. The air-based fryer lid defined in claim 12, wherein the base of the fryer lid is oval shaped.

16. The air-based fryer lid defined in claim 12, further comprising a handle pivotably coupled to the main housing.

17. The air-based fryer lid defined in claim 16, further comprising a safety switch configured to disable power to the fryer lid when the handle is pivoted from a closed position to an opened position and the fryer lid is lifted away from a slow cooker.

18. A rest stand for a fryer lid, comprising:
a first arm; and
a second arm pivotably coupled with the first arm,
wherein, when in an open position, the second arm extends outwardly and perpendicularly from the first arm in opposing direction, and when in a closed position, the second arm extends outwardly and axially from the first arm.

19. The rest stand defined in claim 18, further comprising a base, wherein the first arm is coupled to the base and the second arm is pivotably coupled to the base.

20. The base defined in claim 19, further comprising integral clips in which to hold the pivotably coupled arm to the base when in the closed position.

21. The rest stand defined in claim 18, wherein the first arm comprises at least one recess configured to receive and hold an end portion of the second arm when in the closed position.

22. The rest stand defined in claim 18, wherein when the second arm is pivoted into the open position, the two arms are configured to hold the fryer lid above a surface.
